(19) United States
(12) Patent Application Publication
(10) Pub. No.: US 2007/0143804 A1
(43) Pub. Date: Jun. 21, 2007

(54) System, method and apparatus for distributing Video-On-Demand (VOD)

(75) Inventor: Yeqing Wang, Horsham, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/300,910

(22) Filed: Dec. 15, 2005

(51) Int. Cl. H04N 7/173

(52) U.S. Cl. 725/95; 725/87

(57) ABSTRACT

A system (20), method (60) and apparatus (28) for distributing Video-On-Demand (VOD) content to one or more client devices (28). The system (20) has a more distributed network architecture compared to conventional VOD system architectures, which allows VOD content to be delivered to the client devices (28) more efficiently. The system (20) includes a resource management controller (24) coupled to one or more content servers (22) and coupled to a plurality of client devices (28) via a distributed network link (32). The resource management controller (24) controls the delivery of VOD content to a requesting client device (28) from the one or more servers (22) and/or one or more client devices (28) configured as host client devices. Client devices (28) configured as host client devices can not only request video content from servers and other client devices, but also can transmit video content stored therein to other client devices.

### BACKGROUND OF THE INVENTION

1. Field of the Invention

The invention relates to Video-On-Demand (VOD). More particularly, the invention relates to systems, methods and apparatus for delivering VOD to client devices.

2. Description of the Related Art

Video-On-Demand (VOD) typically refers to an area of technology that allows client device end-users to select video content or other content from a source, such as a central server, for viewing on a suitable end-user display device, such as a television or a computer monitor. One type of VOD system is a “streaming” VOD system, in which video content or other content is streamed from the source to an end-user client device and viewing of the content can begin as soon as the content streams over a suitable network connection from the source to the end-user client device. Another type of VOD system is a “download” VOD system, in which content initially is downloaded to a video processing device, such as a set-top box, before end-user viewing begins. Typically, almost all download VOD systems and many streaming VOD systems allow the end-user to pause, fast forward and rewind the content, as well as to view the content at any time.

Conventional VOD systems typically are based on a central server architecture. That is, typically, a centrally-located server, e.g., at a local headend, transmits VOD content directly to a client device, i.e., an end-user video processing device, such as a set-top box. The video processing device, in turn, decodes and, if necessary, formats the information for viewing on the end-user display, e.g., a television. However, in this central server architecture, the ability of the central server to provide content in a timely manner can be inhibited if an unusually large number of client devices request VOD service at similar times.

### BRIEF DESCRIPTION OF THE DRAWINGS

FIG. 1 is a block diagram of a conventional Video-On-Demand (VOD) system;

FIG. 2 is a block diagram of a Video-On-Demand system having a distributed architecture;

FIG. 3 is a block diagram of the video processing device in the Video-On-Demand system of FIG. 2; and

FIG. 4 is a flow chart of a Video-On-Demand method for the Video-On-Demand system of FIG. 2.

### DETAILED DESCRIPTION

In the following description, like reference numerals indicate like components to enhance the understanding of the Video-On-Demand (VOD) system, method and apparatus through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

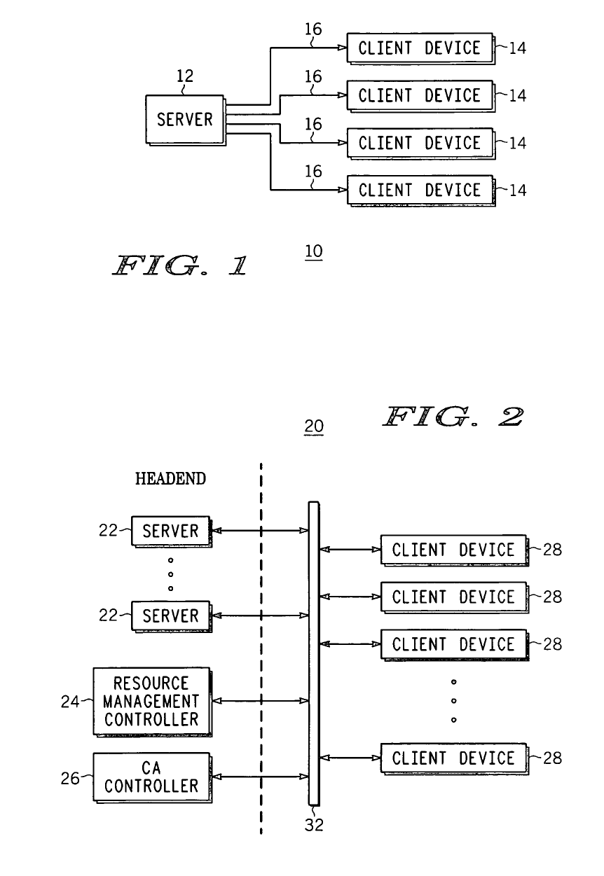

Referring to FIG. 1, shown is a block diagram of a conventional Video-On-Demand (VOD) system 10. Conventional VOD systems typically include a server or video server 12, a plurality of client devices 14 and a transmission medium 16 coupled between the server 12 and each client device 14. The server 12 stores, manages and delivers VOD content requested by a client device via the transmission medium 16, which typically is an optical fiber, a coaxial cable or other suitable transmission medium. The server 12 typically is located in a headend (not shown) or other suitable location within the system 10. The headend typically is a regional or local hub that is part of a larger service provider distribution system, such as a cable television distribution system.

The client devices 14 typically are located in end-user (subscriber) locations, such as an end-user home or office. Often, a home or other end-user location has only one client device 14, although more than one client device 14 can be located in the same end-user location, e.g., as part of a home network or business network configuration.

The VOD system 10 and other conventional VOD systems typically are based on a central server architecture. In such architecture, the server 12 typically is centrally located with respect to the client devices 14 and connects to each client device 14 directly via a dedicated transmission medium 16. However, as discussed hereinabove, the central server system architecture often has difficulty providing VOD content in a timely manner to the client devices 14, e.g., if a relatively large number of client devices 14 request VOD content at the same time, because the server 12 must deliver VOD content to a plurality of client devices 14 via a corresponding plurality of directly-connected transmission media 16.

Referring now to FIG. 2, shown is a block diagram of a VOD system 20 having a more distributed architecture than that of the conventional VOD system 10 in FIG. 1. The VOD system 20 in FIG. 2 includes one or more servers 22, a resource management controller 24, a conditional access (CA) controller 26, and a plurality of client devices 28 all coupled to the resource management controller 24 via a network link or distributed network link (shown generally as 32).

As with the servers 12 in the conventional VOD system 10 shown in FIG. 1, the servers 22 in the VOD system 20 in FIG. 2 store, manage and deliver VOD content requested by various client devices 28. The servers 22 typically are located in one or more headends, and are maintained by a service provider, which can be a television service provider (e.g., a national or local television network), a cable television service provider, an Internet service provider, a satellite broadcast system service provider, or other suitable service provider. The client devices 28 typically are located in any suitable end-user location, e.g., a subscriber home, office or other subscriber premises. Also, it should be understood that more than one client device 28 can be located in a single end-user location.

The VOD content transmitted by the servers 22 typically is a plurality of digital video signals formatted according to a suitable standard, such as the MPEG (Moving Picture Experts Group) 2 or MPEG 4 standard, and multiplexed into a data stream that is modulated on a carrier using quadrature amplitude modulation (QAM) or other suitable modulation technique. As will be discussed in greater detail hereinbelow, the VOD content is transmitted from the servers 22 to the resource management controller resource management controller 24, and transmitted between the resource management controller 24, the distributed network link 32, and the client devices 28 via any suitable network connection or system of network connections. Such subscriber network connection systems can include a Hybrid Fiber Coaxial (HFC) cable system, any suitable Fiber To The Premises (FTTP) system, such as Fiber To The Curb (FTTC) or Fiber To The Home (FTTH), or any suitable number of digital subscriber line systems (xDSL).

Each client device 28 is any suitable signal processing device or system for processing video signals, such as any signal converter or decoder (set-top) box, or other suitable computing device or video device with set-top box and/or cable modem capabilities, including a residential gateway, an internet protocol (IP), satellite or cable digital video recorder, a digital video disk (DVD) recorder, a computer, or a home media server system manufactured by Motorola Corp. or other suitable manufacturer. Also, one or more of the client devices 28 in the system 20 can be comprised of any suitable structure or arrangement, e.g., one or more integrated circuits.

Each one of the client devices 28 in the system 20 can be completely or partially configured in the form of hardware circuitry and/or other hardware components within a larger device or group of components. Alternatively, each of the client devices 28 in the system 20 can be completely or partially configured in the form of software, e.g., as processing instructions or one or more sets of logic or computer code. In such configuration, the logic or processing instructions typically are stored in a data storage device, which typically is coupled to a processor or controller. Both the data storage device and the processor or controller can be included as part of a given client device 28, although such is not necessary. The processor or controller accesses the necessary instructions from the data storage device and executes the instructions or transfers the instructions to the appropriate location within the given client device 28.

The servers 22, the resource management controller 24, the CA controller 26, and each of the client devices 28 is connected to the distributed network link 32 via any suitable network connection, including any suitable home or business network connection or connections. Such connections include, e.g., a token ring, Ethernet, Fast Ethernet, Gigabit Ethernet, any networking connection technology in accordance with the standards established by the Home Phoneline Networking Alliance (HomePNA) or the Multimedia over Coax Alliance (MoCA), powerline networking, and any networking connection technology in accordance with the IEEE 802.11 standard established by the Institute of Electrical and Electronics Engineers. Also, the connections can be or be part of a wired network using Ethernet cables, coaxial cables, fiber optic cables, or can be or be a part of a wireless network or any combination thereof. Moreover, the network connections can support any number of suitable transmission protocols, including the Data Over Cable Service Interface Specification (DOCSIS) transmission protocol and the Transmission Control Protocol/Internet Protocol (TCP/IP).

Unlike conventional VOD systems, the VOD system 20 has a more distributed architecture that allows VOD content to be delivered to the client devices 28 more efficiently compared to conventional VOD system architectures. In general, the VOD system 20 uses the resource management controller 24 to control the delivery of video content to a requesting client device 28 from one or more servers 22 and/or one or more client devices 28 serving as host client devices. As will be discussed in greater detail hereinbelow, one or more of the client devices 28 can be configured as a host client device, allowing it not only to request video content from servers and other client devices, but also to transmit video content stored therein to other client devices.

As shown, all of the client devices 28 are connected to the resource management controller 24 via the distributed network link 32. Also, the servers 22 are connected to the resource management controller 24 via the distributed network link 32. In this manner, at the direction of the resource management controller 24, VOD content from any one or more servers 22 can be delivered to any client device 28 through the distributed network link 32. Also, in this distributed architecture, client devices 28, if properly configured as host client devices, can likewise deliver VOD content to other client devices 28 via the distributed network link 32. Such delivery of VOD content from one or more host client devices 28 also is controlled by the resource management controller 24.

The CA controller 26 is coupled to the distributed network link 32 via any suitable connection, e.g., as discussed hereinabove. In this manner, the CA controller 26 can provide conditional access information to the resource management controller 24 and to the client devices 28 via the distributed network link 32.

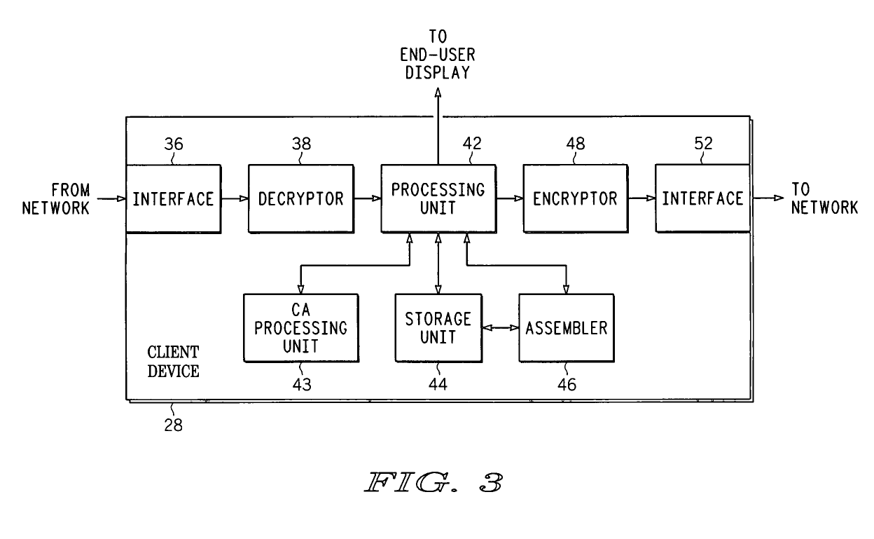

Referring now to FIG. 3, shown is a block diagram of a client device 28 in the VOD system of FIG. 2. The client device 28 in FIG. 3 is shown configured as a host client device suitable for delivering VOD content to other client devices. However, the client device 28 also is suitable for requesting and receiving VOD content from one or more servers 22 and/or one or more other host client devices. Also, it should be understood that the client device 28 can have a bus structure rather than the particular structure shown.

The client device 28 includes a first interface or input interface 36, a decryptor 38, a processing unit 42, a conditional access (CA) processor or processing unit 43, a storage unit 44, an assembler 46, an encryptor 48, and a second or output interface 52. As discussed hereinabove, the client device 28 can request and receive video information or signals, such as VOD content, from a suitable source. The client device 28 also can decode and, if necessary, format the information for viewing on an end-user display device, and deliver the formatted information to an appropriate end-user display device associated therewith or coupled thereto. Therefore, in addition to the components shown, the client device 28 includes conventional components and hardware (not shown) suitable for such operations.

Within the client device 28, the input interface 36 receives VOD content and other suitable information from an appropriate source, e.g., from one or more servers 22 and/or one or more other client devices 28, in a conventional manner via the network link 32. The decryptor 38, which is coupled to the input interface 36, decrypts any encrypted VOD content that is received by the client device 28. Often, VOD content is encrypted to prevent unauthorized copying of the VOD content. The decryptor 38 decrypts or removes the encryption from the VOD content so that the VOD content can be processed (e.g., stored, assembled, transmitted) properly by the client device 28.

The processing unit 42, which is coupled to the decryptor 38, receives the decrypted VOD content. As will be discussed in greater detail hereinbelow, the processing unit 42 controls and coordinates the storage, assembly, transmission and other suitable processing tasks applied to or performed on the VOD content received by the client device 28. As such, the processing unit 42 is coupled to both the storage unit 44 and the assembler 46. The processing unit 42 also can be coupled to a suitable end-user display device or other suitable device for transmission of the VOD content thereto. The processing unit 42 also is coupled to the encryptor 48. For example, once processing of the VOD content received by the client device 28 is complete, the processing unit 42 can deliver the VOD content to the encryptor 48.

The conditional access (CA) processing unit 43, which is coupled to the processing unit 42, can include conditional access information that can be provided to the processing unit 42 for conditional access purposes. For example, as will be discussed in greater detail hereinbelow, the CA processing unit 43 can provide CA information necessary to verify that the client device 28 is authorized to receive requested VOD content.

The storage unit 44, which is coupled to the processing unit 42, stores some, all or none of the VOD content received by the client device 28, as directed by the processing unit 42. The storage unit 44 is any suitable information storage unit, such as any suitable magnetic or optical storage device, including magnetic disk drives, optical drives, tape drives, and memory devices including random access memory (RAM) devices, read-only memory (ROM) and flash memory. Also, although the storage unit 44 is shown within the client device 28, the storage unit 44 can be located external to the client device 28 and suitably coupled thereto.

The assembler 46, which is coupled to the storage unit 44 and the processing unit 42, assembles various portions of VOD content, as will be discussed in greater detail hereinbelow. The assembler 46 operates under the direction of the processing unit 42, and can receive VOD content for assembly from the storage unit 44 and/or the processing unit 42. The assembler 46 can also deliver assembled VOD content to the storage unit 44 and/or the processing unit 42, as directed by the processing unit 42.

Once the client device 28 has processed the VOD content, and prior to any VOD content being transmitted from the client device 28, the encryptor 48 receives the VOD content from the processing unit 42 and may encrypt (or re-encrypt) the VOD content. The output interface 52, which is coupled to the output of the encryptor 48, then receives the encrypted VOD content from the encryptor 48 and transmits or delivers the VOD content to a suitable destination, e.g., a requesting client device 28, via the network link 32 and under the direction of the resource management controller 24.

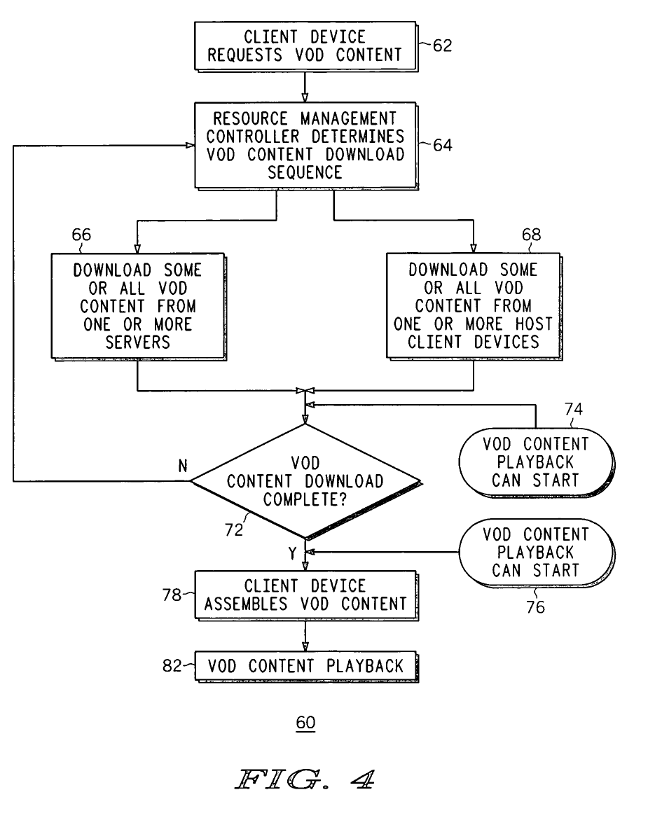

Referring now to FIG. 4, with continuing reference to FIG. 2 and FIG. 3, shown is a flow chart of a VOD method 60 for the VOD system of FIG. 2. The method 60 will be described along with the operation of the system 20 shown in FIG. 2 and the client device 28 shown in FIG. 3.

The method 60 includes the step 62 of a client device 28 requesting VOD content. The client device 28 that desires VOD content initiates a request for VOD content. For example, an end-user may select a VOD program from among a plurality of available VOD programs via an end-user interface (e.g., a remote control device) used to operate an end-user device associated with the particular client device 28.

The VOD content request by the client device 28 typically is received by the resource management controller 24 via the network link 32 and, in response thereto, the method 60 includes the step 64 of the resource management controller 24 determining the VOD content download sequence. As will be discussed in greater detail hereinbelow, the VOD content download sequence is the manner or sequence in which one or more of the servers 22 and/or one or more of the host client devices 28 deliver the requested VOD content to the requesting client device 28.

It should be understood that the requested VOD content can be downloaded to the requesting client device as a single download or, alternatively, as a plurality of downloads that each deliver a portion or segment of the requested VOD content. Therefore, in this manner, the requested VOD content can be obtained wholly from a single download source or as a plurality of VOD content portions from a plurality of download devices, i.e., one or more servers 22 and/or one or more host client devices 28.

In step 64 of the method 60, the resource management controller 24 tries to locate the requested VOD content from one of the servers 22. Depending on whether the particular server 22 contains the requested VOD content, the resource management controller 24 may also try to locate the requested VOD content from one or more of the other servers 22 and/or one or more of the host client devices 28 via the network link 32. As discussed hereinabove, host client devices are client devices that, unlike conventional client devices, are configured to be able to transmit VOD content to other client devices via the resource management controller 24 and the network link 32, as well as receive VOD content that it may request. Thus, if one or more of the host client devices has stored therein the requested VOD content, those host client devices are potential sources for downloading the requested VOD content to the requesting client device.

In addition to determining the availability of the requested VOD content from one or more of the servers 22 and/or one or more of the host client devices 28, the resource management controller 24 also determines the level of traffic or the traffic condition at each of the devices that is a potential VOD content source. For example, the resource management controller 24 can use one or more conventional traffic monitoring protocols to determine the current traffic at the potential VOD content source devices. Thus, if one of the servers 22 has stored therein all or a portion of the requested VOD content, but currently is experiencing a relatively large amount of data traffic (e.g., transmitting, storing, receiving or otherwise processing data), the resource management controller 24 may not choose to use that particular server to deliver any of the requested VOD content to the requesting client device 28. It should be understood that traffic includes not only video content, but also any other suitable information transmitted from and/or received by the one or more of the servers 22 and/or the one or more of the host client devices 28, including, e.g., messaging and other information related to or not related to VOD content and status indicator information.

Based on the availability of the requested VOD content and the current traffic condition at one or more of the potential VOD content download sources, the resource management controller 24 determines an appropriate download sequence for transmitting the requested VOD content to the requesting client device 28. For example, as determined by the resource management controller 24, the appropriate download sequence for a given VOD content request may include downloading a first portion of the requested VOD content from one of the servers 22 and downloading a second and third portion of the requested VOD content from one or more host client devices 28.

Once the resource management controller 24 determines an appropriate VOD content download sequence, the method 60 may perform the step 66 of downloading VOD content from one or more of the servers 22 and/or may perform the step 68 of downloading VOD content from one or more of the host client devices 28. The downloading step 66 and the downloading step 68 are coordinated by and performed under the direction of the resource management controller 24. For VOD content being downloaded from one or more of the servers 22, the downloading step 66 includes downloading all or a portion of the requested VOD content from the particular server or servers to the requesting client device 28 via the network link 32. For VOD content being downloaded from one or more of the host client devices 28, the downloading step 68 includes the particular host client device or devices 28 transmitting all or a portion of the requested VOD content to the requesting client device 28 via the network link 32. Thus, in this manner, VOD content downloading is coordinated by the resource management controller 24.

Once the downloading of the requested VOD content to the requesting client device 28 has begun, the method 60 includes determining (shown as 72) whether the VOD content download has been successfully completed. If the VOD content download has not yet been completed, the resource management controller 24 continues to monitor and coordinate the download sequence among one or more of the servers 22 and/or one or more of the host client devices 28 until the download of the requested VOD content has been completed.

For example, if the VOD content download sequence involves downloading a first portion of the requested VOD content from a server 22 and a second portion of the requested VOD content from a host client device 28, the resource management controller 24 may initiate the downloading step 66, i.e., downloading the first portion of the VOD content from the appropriate server 22. Then, the resource management controller 24 may inquire about the status of the download after the server 22 has downloaded the first portion of the requested VOD content. Upon determining 72 that the VOD content download is not complete, the resource management controller 24 will then initiate the downloading step 68, i.e., downloading the second portion of the VOD content from the appropriate host client device 28. Alternatively; the requesting client device 28 may initiate subsequent download requests from the resource management controller 24, e.g., based on the time required to download previous VOD content portions and/or the size of previously downloaded VOD content portions.

Once the second portion of the requested VOD content has been downloaded to the requesting client device 28, the resource management controller 24 may again inquire about the status of the VOD content download. Upon determining 72 that the VOD content download is successfully complete, the resource management controller 24 may notify the requesting client device 28 and the VOD content downloading sources, e.g., in an appropriate manner, that the download is complete.

Prior to any VOD content download, it may be necessary to verify that the client device requesting the VOD content is authorized to receive the requested VOD content. Often, VOD content is considered premium content that is available only to those end-users who have paid for such premium content. The conditional access (CA) controller 26, which is coupled to the client devices 28 via the network link 32, can verify if a client device requesting VOD content is authorized to receive such content. For example, the CA controller 26 may contain authorization information about one or more of the client devices 28 connected to the network link 32. The CA controller 26 may obtain such information by polling one or more client devices 28 for their respective configurations as they relate to their ability to receive VOD content. 100411 In this manner, if the CA controller 26 determines that a requesting client device 28 is not authorized to receive the requested VOD content, the CA controller 26 can alert the requesting client device 28, and, if necessary, alert the resource management controller 24 or have the requesting client device 28 alert the resource management controller 24. The resource management controller 24 then can perform an appropriate task, e.g., the resource management controller 24 can query the requesting client device 28 for payment for the requested VOD content or the resource management controller 24 can fail to initiate a download sequence on behalf of the requesting client device 28.

Alternatively, the CA controller 26 can provide necessary encryption or authorization keys to the VOD content as the VOD content it is being downloaded from one or more download sources to the requesting client device 28. In this manner, even if the requested VOD content is downloaded to the requesting client device 28, the requesting client device 28 will not be able to properly store, assemble or otherwise process the received VOD content if the requesting client device 28 can not decrypt the encryption or authorization keys added to the VOD content by the CA controller 26. Similarly, the CA controller 26 can alert any potential download sources or apply encryption or authorization keys to the VOD content contained therein that potentially may be downloaded to requesting client devices 28.

Referring again to the method 60 shown in FIG. 4, it should be understood that a client device 28 receiving VOD content can initiate playback of the downloaded VOD content either before the VOD content download is complete (step 74), i.e., as the VOD content download is being performed, or after the VOD content download is complete (step 76). As the requested VOD content is being downloaded to the requesting client device 28, the VOD content may be decrypted, e.g., by the decryptor 38, before it is passed on to the processing unit 42 for processing, as discussed hereinabove. Typically, the processing unit 42 passes the VOD content to the storage unit 44 for storage, particularly if the VOD content is being downloaded in multiple portions. The stored VOD content then can be retrieved later for assembly, if necessary, or for delivery to and playback by the end-user display device associated with the client device 28.

However, alternatively, the processing unit 42 can pass the downloaded VOD content directly to the end-user device associated with the particular client device 28 as the VOD content is being received by the client device 28. In this manner, the processing unit 42 or other suitable component in the client device 28 should have a sufficient buffer of downloaded VOD content before allowing playback of the VOD content to be initiated.

As discussed hereinabove, VOD content can be downloaded in portions, e.g., by one or more VOD content sources. VOD content downloaded to the requesting client device 28 in this manner typically is assembled before the downloaded VOD content is suitable for delivery to an end-user device. In this manner, the method 60 includes the step 78 of assembling VOD content downloaded to the requesting client device 28. The VOD content is assembled by the assembler 46, e.g., as directed by the processing unit 42.

The assembler 46 is coupled to the processing unit 42 and the storage unit 44. Thus, the assembler 46 can retrieve VOD content portions stored in the storage unit 44, assemble the VOD content portions, and deliver the assembled VOD content back to the storage unit 44 or to the processing unit 42. Alternatively, the assembler 46 can receive VOD content portions directly from the processing unit 42, assemble the VOD content portions, and deliver the assembled VOD content to the storage unit 44 or back to the processing unit 42.

The method 60 also includes the step 82 of playing back the VOD content. If playback of the VOD content downloaded to the requesting client device 28 has not yet been initiated by the playback step 74 or the playback step 76, playback of the VOD content can be initiated by the playback step 82.

The method shown in FIG. 4 may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the VOD system, method and apparatus herein described without departing from the spirit and scope of the invention as defined by the appended claims and their full scope of equivalents.

1. A Video-On-Demand (VOD) system, comprising:
a server having video content;
a resource management controller coupled to the server via a network connection;
at least one host client device coupled to the resource management controller via a network connection; and
at least one requesting client device coupled to the resource management controller via a network connection and coupled to the host client device via a network connection,
wherein, in response to the requesting client device requesting video content, the resource management controller is configured to instruct at least one of the server and the host client device to transmit to the requesting client device at least a portion of the requested video content,
wherein the transmission of the requested video content to the requesting client device from at least one of the server and the host client device is based on the amount of traffic at the server and at the host client device.

2. The system as recited in claim 1, wherein the host client device includes a video content storage unit for storing video content, and includes a processing unit for transmitting video content stored in the video content storage unit.

3. The system as recited in claim 1, wherein the requesting client device includes a video content storage unit for storing video content transmitted from at least one of the server and the host client device.

4. The system as recited in claim 1, wherein the video content is transmitted to the requesting client device as a plurality of video content portions, and wherein the requesting client device is configured to assembly the plurality of video content portions transmitted to the requesting client device.

5. The system as recited in claim 1, wherein the server further comprises a first server and at least one second server, and wherein, in response to the requesting client device requesting video content, the resource management controller instructs at least one of the first server, the at least one second server, and the host client device to transmit to the requesting client device at least a portion of the requested video content in such a manner that the requesting client device receives all of the requested video content.

6. The system as recited in claim 1, wherein the host client device further comprises a first host client device and at least one second host client device, and wherein, in response to the requesting client device requesting video content, the resource management controller instructs at least one of the server, the first host client device and the at least one second host client device to transmit to the requesting client device at least a portion of the requested video content in such a manner that the requesting client device receives all of the requested video content.

7. The system as recited in claim 1, wherein the host client device and the requesting client device are coupled together via a data transmission channel that transmits data according to at least transmission protocol selected from the group consisting of a Data Over Cable Service Interface Specification (DOCSIS) transmission protocol and Internet Protocol (IP) transmission protocol.

8. The system as recited in claim 1, wherein at least one of the host client device and the requesting client device further comprises a device selected from the group consisting of a video processing device, a set-top box, a signal converter box, a signal decoder box, a residential gateway, a digital video recorder, a computer, and a home media server.

9. The system as recited in claim 1, wherein the requesting client device is coupled to the resource management controller and coupled to the host client device via at least one distribution network connection.

10. A computer program embodied in a computer-readable medium for delivering Video On-Demand (VOD) content to at least one first client device, wherein the first client device is coupled to a resource management controller and coupled to at least one second client device, wherein the resource management controller is coupled to at least one server containing VOD content, the program comprising:
instructions for transmitting at least a portion of the requested VOD content by at least one of the server and the second client device to the first client device in such a manner that the first client device receives the requested VOD content,
wherein the transmitting instructions are based on the amount of traffic at the server and at the second client device.

11. The program as recited in claim 10, wherein the at least one server further comprises a first server and at least one second server, and wherein the transmitting instructions further comprise instructions for transmitting at least a portion of the requested VOD content by at least one of the first server, the at least one second server, and the second client device to the first client device in such a manner that the first client device receives all of the requested VOD content, and wherein the transmitting instructions are based on the amount of traffic at the first server, the at least one second server, and the second client device.

12. The program as recited in claim 10, wherein the at least one second client device further comprises a plurality of second client devices, and wherein the transmitting instructions further comprise instructions for transmitting at least a portion of the requested VOD content by at least one of the server and the plurality of second client devices to the first client device in such a manner that the first client device receives all of the requested VOD content, and wherein the transmitting instructions are based on the amount of traffic at the server and at the plurality of second client devices.

13. The program as recited in claim 10, wherein the VOD content is transmitted to the first client device as a plurality of VOD content portions, and wherein the program further comprises instructions for assembling the plurality of VOD content portions transmitted thereto by the first client device.

14. The program as recited in claim 10, further comprising instructions for storing by the first client device the requested VOD content transmitted thereto.

15. A Video On-Demand (VOD) client device, comprising:
an input interface for receiving VOD content from at least one source coupled to the client device;
a processing unit coupled to the input interface for processing VOD content received by the client device; and
a storage unit coupled to the processing unit for storing video content received by the client device,
wherein the processing unit is configured to receive VOD content from at least one server and from at least one other VOD client device, and
wherein the processing unit is configured to transmit VOD content to at least one other VOD client device and to at least one end-user display device.

16. The client device as recited in claim 15, further comprising an assembler coupled to the processing unit and the storage unit for assembling portions of VOD content received by the client device.

17. The client device as recited in claim 15, further comprising a decryptor coupled between the input interface and the processing unit for decrypting VOD content received by the client device.

18. The client device as recited in claim 15, further comprising an encryptor coupled to the processing unit for encrypting VOD content transmitted by the client device.

19. The client device as recited in claim 15, further comprising a conditional access (CA) processor coupled to the processing unit for transmitting conditional access information between the conditional access (CA) processor and the processing unit.

20. The client device as recited in claim 15, wherein at least a portion of the client device is contained in a device selected from the group consisting of a signal converter box, a signal decoder box, a residential gateway, a digital video recorder, a computer, and a home media server.
